(19) United States
(12) Patent Application Publication
(10) Pub. No.: US 2026/0170961 A1
(43) Pub. Date: Jun. 18, 2026

(54) INTELLIGENT TRANSPORT SYSTEM AND METHOD FOR IMPROVING ROAD SAFETY, METHODS FOR ROAD USERS AND ELECTRONIC DEVICE

(71) Applicant: Volkswagen Aktiengesellschaft, Wolfsburg (DE)

(72) Inventors: Patrick Diekhake, Wolfsburg (DE); Razvan Racu, Wolfsburg (DE)

(21) Appl. No.: 19/410,836

(22) Filed: Dec. 5, 2025

(30) Foreign Application Priority Data
Dec. 16, 2024 (EP) 24220205.9

(51) Int. Cl. G08G 1/16; G06V 20/54; G08G 1/01

(52) U.S. Cl. CPC G08G 1/164; G06V 20/54; G08G 1/0116; G08G 1/0133; G08G 1/0141; G08G 1/0145; G08G 1/166; G06V 2201/08

(57) ABSTRACT

An intelligent transport system in which a road infrastructure component and/or a first road user detects an event relating to road safety and broadcasts information about the event locally using direct communication signals. Surrounding road users receive the broadcast and, when connected to or connectable with a backend server, determine the relevance of the event and upload the associated information to the backend server. Road users outside the range of the direct communication signals may download the uploaded information from the backend server to become aware of or be warned about the event. The disclosed system also includes methods performed by first and second road users, an electronic device configured to execute the methods, and computer programs for implementing the described functionalities.

### RELATED APPLICATIONS

The present application claims priority to European Patent App. No. 24220205.9, filed Dec. 16, 2024 to Diekhake et al., the contents of which is incorporated by reference in its entirety herein.

### TECHNICAL FIELD

The present disclosure relates to an intelligent transport system and to a method for improving road safety. Further, the present disclosure pertains to a method for a first road user and a method for a second road user. Moreover, the present disclosure relates to an electronic device and to computer programs.

### BACKGROUND

Vehicle-to-Everything (V2X) communications are expected to become a key pillar for increasing safety and efficiency in road transportation. Various V2X communication technologies are available, which are used, among other purposes, for exchanging hazard information.

One example of V2X communication is direct communication (also referred to as ad-hoc communication), in which information is transmitted only between vehicles in the immediate vicinity of a transmitting vehicle (e.g., up to a radius of approximately 1 km). These communication signals and their associated data can be received only by vehicles within this radius that support the direct communication technology. If the receiving vehicle determines that the received data is not relevant, the data is discarded.

Another example of inter-vehicle communication is network communication. In network-based implementations, vehicles may connect to, for example, a cloud network and exchange data via that network. A vehicle that detects an event may upload information regarding the event to the cloud network. Other vehicles can then download the event information to be alerted to the event.

Document FR 3 100 203 A1 describes a method and device for warning a vehicle in which information representative of road conditions in a determined area of a road environment is received and compared with historical information representative of road conditions associated with the determined area. An alert is generated based on a result of the comparison.

Document EP 4 307 269 A1 suggests a Cooperative Intelligent Transport System (C-ITS). In response to detecting a situation involving an object detected within an area monitored by the ITS, a Collective Perception Message (CPM) is generated and transmitted. The CPM includes a reference to the object and an indication that the object is involved in the situation.

Document WO 2015/133181 A1 pertains to a communication apparatus, a communication control method, and a program. A reception unit receives messages transmitted from multiple transmission-source devices, including information and corresponding identifiers of the transmission sources. A control unit executes, according to the types of messages received, a transmission operation to transmit, as a representative of messages indicating the same information and received from different transmission-source devices, a representative message indicating the same information.

Document US 2018/0184245 A1 discloses a vehicle, a server, and a system for preventing transmission of redundant information by communicating with vehicles that can collect information about another vehicle that cannot communicate with a server.

### SUMMARY

In direct communication applications, events are shared with all receiving vehicles via local broadcasting, but only within a limited range, for example in the immediate vicinity of the transmitting vehicle. Although this allows external events to be collected by receiving vehicles, such vehicles will discard any events deemed irrelevant to their own circumstances. In network-based applications, the focus is primarily on downloading events, and only events detected by a given vehicle itself are typically considered for uploading.

Even if vehicles upload events received from other vehicles into a cloud system, the communication network may become unduly congested, and the cloud may accumulate large amounts of redundant event data, ultimately resulting in slow or overloaded databases. Accordingly, some aspects of the present disclosure address a general demand for improving road safety.

This objective is addressed by the intelligent transport system and method for improving road safety, the method for a first road user, the method for a second road user, the electronic device, and the computer programs as defined in the independent claims. Further advantageous aspects and configurations will become apparent from the dependent claims and the following description.

In some examples, an intelligent transport system (ITS) for improving road safety is disclosed. ITSs may generally employ various technologies to monitor, evaluate, and manage transport systems to improve safety and efficiency, for example by optimizing traffic flow. Such systems may link transport infrastructure and vehicles using information and communication technologies, computers, electronics, and sensors.

The ITS comprises a backend server, a road infrastructure, a first road user, a second road user, and a third road user. Each road user includes an electronic device. The backend server includes at least one remotely located server that is accessible from any location via a secure and protected Internet connection. In other words, the backend server represents a cloud-based storage location external to the user's physical environment to which data, applications, and computing tasks may be transferred and processed.

The road infrastructure may include a roadside unit (RSU). An RSU may be used in ITS and connected-vehicle environments and may be positioned alongside roads or highways to facilitate communication between vehicles and the transportation infrastructure, for example to support Vehicle-to-Infrastructure (V2I) and Vehicle-to-Everything (V2X) communication. The RSU includes a communication module configured to exchange information with vehicles in the vicinity of the RSU. For example, the communication module may support Dedicated Short-Range Communication (DSRC) or Cellular Vehicle-to-Everything (C-V2X) communication.

In some examples, a method for improving road safety is disclosed. The method may be used in connection with the ITS described herein. The features and advantages of the ITS may be applied analogously to the method for improving road safety.

In some examples, a method for a second road user is disclosed. The features, functions, and advantages described for improving road safety may be applied analogously to the method for the second road user.

Each of the electronic devices and/or control units described herein may be implemented by electrical or electronic components (hardware) or by firmware (e.g., ASICs). Additionally or alternatively, the functionality of the electronic devices and/or control units may be realized through execution of suitable software programs. A combination of hardware, firmware, and software may also be used. For example, individual components of the electronic devices and/or control units that provide specific functionalities may be implemented as separate integrated circuits or as components of a common integrated circuit.

The individual components of the electronic devices and/or control units may be implemented as one or more processes executing on one or more processors in one or more electronic computing devices and generated through the execution of one or more computer programs. The computing devices may cooperate with one another or with external systems to provide the functionalities described herein. Instructions for the computer programs may be stored in a memory, such as a RAM element, or in a non-volatile storage medium such as a CD-ROM, flash memory, or similar device.

It will be apparent to a skilled person that the functionalities of multiple computing units (data processing devices) may be combined in a single device, or that the functionality of one device may be distributed among several devices to implement the functions of the electronic devices and/or control units described herein.

A further aspect of the present disclosure relates to a computer program comprising instructions which, when executed by a computer such as an electronic device and/or control unit, cause the computer to perform any of the methods described herein, including a method for improving road safety and/or a method for a road infrastructure component and/or a first road user and/or a second road user.

Additional preferred configurations of the present disclosure arise from the features recited in the dependent claims.

The various examples and configurations described herein may be combined with each other, unless otherwise specified in an individual case.

### BRIEF DESCRIPTION OF THE DRAWINGS

Various aspects and advantages of the present disclosure will become apparent to those skilled in the art from the following detailed description of examples, when read in view of the accompanying drawings. It shows:

FIG. 1 schematically illustrates an intelligent transport system in an exemplary traffic situation, according to some aspects of the present disclosure.

FIG. 2 schematically illustrates the intelligent transport system in another exemplary traffic situation, according to some aspects of the present disclosure.

FIG. 3 schematically illustrates the intelligent transport system of FIG. 2, according to some aspects of the present disclosure.

FIG. 4 schematically illustrates a flow chart of a method for improving road safety, according to some aspects of the present disclosure.

FIG. 5 schematically illustrates an electronic device for a road user, according to some aspects of the present disclosure.

### DETAILED DESCRIPTION

In the following description, recurring and similar features in this and the subsequent representations are identified with the same reference numerals, and a repetitive description of such features is omitted.

In various examples disclosed herein, the electronic device of the first road user and/or the road infrastructure of the intelligent transport system (ITS) is configured to detect an event in its environment relating to a threat to road safety and to upload at least a portion of the information associated with the detected event to the backend server, depending on whether a connection to the backend server is available. In other words, the road infrastructure and/or the first electronic device may be configured to determine whether a connection to the backend server is possible. If a connection is available, the information associated with the detected event is uploaded to the backend server. If no connection is available, the information associated with the detected event is not uploaded.

The electronic device of the first road user and/or the road infrastructure is further configured to broadcast a road-user-to-Everything (R2X) and/or an Infrastructure-to-Road-User (I2R) direct communication signal that includes information associated with the detected event. More specifically, the electronic device may include an R2X communication module, a sensor unit configured to scan at least part of the environment for events posing a threat to road safety such as one or more cameras or a surround-view camera system—and a processor configured to detect an event based on sensor data and to broadcast an R2X and/or I2R direct communication signal using the communication module. The direct communication signal may include an event type, an event position, an event detection time, and/or a specification of the detection means used to detect the event, such as a front or rear camera or a surround-view camera system. Direct communication enables vehicles and/or infrastructure components to communicate directly with one another without routing the communication through an external server or communication node. For example, one or more of the road users may be vehicles that include the electronic device as part of a control unit and associated sensors. In such cases, the communication may be referred to as Vehicle-to-Everything (V2X) and Infrastructure-to-Vehicle (I2V) communication. V2X communication enables information exchange among vehicles and other nodes, and may include Vehicle-to-Vehicle (V2V), Vehicle-to-Infrastructure (V2I), Vehicle-to-Network (V2N), and/or Vehicle-to-Pedestrian (V2P) communication.

The broadcast R2X and/or I2R direct communication signal further includes cloud-upload information indicating whether the event has been uploaded to the backend server. The cloud-upload information may indicate that the event has been uploaded by the transmitter of the direct communication signal (“Yes”), has not been uploaded (“No”), or has already been uploaded by another entity (“Not Needed”). Including cloud-upload information in the direct communication signals prevents unwanted repetitive uploads that would normally occur due to the broadcast nature of direct communication. Events detected by devices that are currently unable to connect to the backend server can still be uploaded by other devices without creating excessive redundancy in the backend database. As a result, the backend server can maintain a relatively lean and high-quality dataset.

The electronic device of the second road user is configured to receive the R2X and/or I2R direct communication signal broadcast by the first road user and/or the road infrastructure and to upload at least part of the information associated with the detected event to the backend server based on the cloud-upload information. In other words, the second electronic device is configured to connect to the backend server for data exchange. Instead of automatically discarding the event information due to spatial or temporal irrelevance, the second electronic device may upload the received event information to the backend server, thereby enriching the database for the benefit of other road users. Uploading such information can improve road safety by increasing the availability of accurate environmental information. Advantageously, the frequency of road-user crashes and the number of associated fatalities may be reduced. However, if the cloud-upload information indicates that the event information has already been uploaded, the second electronic device does not upload the information again, thereby preventing redundant uploads. Events may be identified as identical or equivalent based on event information such as event position, heading of the detecting device, detection time, an event-history match, and similar criteria. One or more of the electronic devices and/or road infrastructures may be configured to identify identical or equivalent events based on these factors. Event matching therefore prevents redundant uploads of information about the same or equivalent events. Such matching may be performed by any of the electronic devices described herein and/or by the backend server, depending on the availability of event-comparison data.

The electronic device of the third road user is configured to download at least part of the information associated with the detected event from the backend server and to determine the relevance of the detected event for the third road user based on the downloaded information. The third electronic device is further configured to output the determined relevance and/or prepare a countermeasure based on the determined relevance. For example, the downloaded information may include one or more of an event type, an event position, an event detection time, a type of detection means, and a warning associated with the detected event. One or more of these pieces of information may be used to determine the relevance of the event. A warning may be provided to the third road user if the determined relevance exceeds a threshold. Accordingly, the third road user may be warned and can react appropriately, or an automatically prepared countermeasure may mitigate or substantially eliminate the risk posed by the event. As a result, the risk of a crash involving the third road user may be reduced, and road safety for the third road user and surrounding road users may be improved.

In some examples, the threat to road safety may relate to a road hazard, a driving environment, and/or a traffic condition in the environment of the road infrastructure and/or the first electronic device. In particular, the threat may relate to abnormal traffic conditions, where “abnormal” refers to traffic conditions that deviate significantly from average or expected conditions, which may be calculated based on historical data. Examples of road hazards include slow vehicles, wrong-way drivers, pedestrians, animals, obstacles on the road, or stationary vehicles such as vehicles stopped due to breakdown or illegal parking. Examples of driving-environment conditions include weather phenomena such as snow, rain, sun glare, and icy roads. Examples of traffic conditions include traffic jams, roadworks, accidents, or passing emergency vehicles. The specific threat to road safety may be used to determine the event type, which may be included in the R2X and/or I2R direct communication signal. As a result, other road users may be made aware of the event type and may determine relevance or prepare countermeasures accordingly.

In some examples, the electronic device of the second road user may be configured to upload at least part of the event information to the backend server if the cloud-upload information indicates that the event has not yet been uploaded. The second electronic device may further be configured to broadcast a second R2X direct communication signal including the event information and cloud-upload information indicating that the event has been uploaded. Advantageously, road users in the vicinity of the second road user, including the first road user, can be informed that the previously unreported event has now been uploaded by the second road user. This prevents any further redundant uploads of the same event information to the backend server.

In some examples, the electronic device of the first road user may be configured to identify that information associated with the detected event was previously stored in a memory of the electronic device before detection of the event, and to set the cloud-upload information included in the R2X and/or I2R direct communication signal to indicate that uploading the event to the backend server is not needed. In other words, the event detected by the first road user may already be known, for example due to prior direct communication signals exchanged with other road users and/or road infrastructures that detected the event earlier, and/or due to communication with the backend server in which the event was already present in a database. Advantageously, this prevents redundant uploads of the same event information to the backend server. Additionally or alternatively, the electronic device of the second road user may be configured to identify that information associated with the detected event was stored in a memory of the second electronic device prior to receiving the R2X and/or I2R direct communication signal, and to broadcast a second R2X direct communication signal including the event information with cloud-upload information set to indicate that uploading the event is not needed. Similarly, redundant uploads of the same event information by other road users may be prevented.

In some examples, the R2X and/or I2R direct communication signal may further include cloud-reference-time information indicating the time at which the event was uploaded to the backend server. The cloud-reference-time information may support identifying equivalent events. Furthermore, the cloud-reference-time information may help determine whether the detected event is still relevant for a particular road user during relevance evaluation, and/or whether the detected event may be considered terminated. As a result, the likelihood of redundant uploads of the same event information may be further reduced.

In some examples, the electronic device of the second road user may be configured to broadcast a third R2X direct communication signal including a Cooperative Awareness Message (CAM) for indicating the presence of the second road user to surrounding road users and/or road infrastructures. A CAM may be generated periodically at a frequency controlled by the originating electronic device and may include information such as speed, position, and steering direction of the electronic device, and optionally information about surrounding road users, as defined in ETSI EN 302 637-2 V1.4.1 (2019 April). The CAM may be extended to include cloud-connected information indicating whether the electronic device is connected to the backend server. Based on the cloud-connected information, surrounding road users may determine which road users are connected to the backend server. The CAM may also be configured to be forwarded once by a receiver, for example through a hop-limit of one, enabling indirect communication with road users located within a single hop of the CAM receiver.

The road infrastructure and/or the electronic device of the first road user may be configured to receive and forward the third R2X direct communication signal via broadcast and to receive and forward one or more R2X direct communication response signals, for example CAMs corresponding to the CAM described above (including cloud-connected information and a hop-limit of one). In other words, the road infrastructure and/or the first electronic device may act as a communication node for exchanging direct communication signals between road users that may normally be outside each other's direct-communication range. Advantageously, information about the presence of road users connected to the backend server within the direct-communication range of the road infrastructure and/or the first electronic device can be distributed efficiently between them.

The electronic device of the second road user may be further configured to receive the one or more R2X direct communication response signals and to determine whether a plurality of road users connected to the backend server is present in the environment of the first road user and/or the road infrastructure. If a plurality of connected road users is determined to be present, uploading the event information from the second electronic device to the backend server may depend on a predetermined condition. If a plurality of connected road users is not present, the second electronic device may upload the event information to the backend server. The predetermined condition may prioritize which of the connected road users is eligible to upload the event information. In other words, a consensus algorithm may be used to determine which of multiple connected road users shall upload the event information. Therefore, even in complex scenarios with multiple connected road users, the event information may be uploaded while preventing redundant uploads.

In some examples, the predetermined condition may refer to or correspond to a distance to the first road user and/or a connectivity measure with respect to the backend server. For example, the road user having the smallest distance to the first road user may be prioritized to upload the event information, ensuring high signal quality and minimizing risk of corruption. Alternatively or additionally, connectivity may be evaluated based on connection stability and/or connection speed. For example, the road user having the most stable and/or fastest connection may be eligible to upload the information. Advantageously, this ensures that the backend server database contains high-quality information.

In some examples, the distance to the first road user and/or the road infrastructure may be determined based on location information included in the exchanged CAMs, such as Global Navigation Satellite System (GNSS) coordinates (e.g., GPS), and/or by time-of-flight measurements of direct communication signals exchanged between road users. Since distances can be calculated using exchanged CAMs, the prioritization of the uploading road user based on distance may be implemented easily and cost-effectively.

In some examples, the broadcast R2X and/or I2R direct communication signal may include or consist of a Decentralized Environmental Notification Message (DENM) associated with the detected event, extended with cloud-upload information. In other words, the road infrastructure and/or the first electronic device may broadcast a direct communication signal that includes or consists of a DENM associated with the detected event and extended with cloud-upload information. A DENM, defined in ETSI EN 302 637-3 V1.2.2 (2014 November), is a message exchanged between road users containing location, traffic, and hazard information. The DENM extended with cloud-upload information may be transmitted as a standalone message. Using such a standalone message allows reliance on well-established and standardized protocols, reduces communication overhead, and increases the likelihood that receiving road users can process or extract the information. Although DENM and CAM are distinct standardized ETSI message formats, each may be extended with cloud-upload or cloud-connected information as described herein.

In some examples, the electronic device of the second road user may be further configured to broadcast a second R2X direct communication signal including a CAM for indicating its presence to surrounding road users and/or road infrastructures. The road infrastructure and/or the first electronic device may be further configured to receive the second R2X direct communication signal and to broadcast or re-broadcast the R2X and/or I2R direct communication signal including the event information in response. Since transmitters of direct communication signals do not receive acknowledgments confirming reception, retransmission of the direct communication signal in response to a received CAM from the second road user improves the likelihood that the second road user remains within communication range and successfully receives the direct communication signal. As a result, it becomes highly likely that the event information will be received and uploaded to the backend server by the second road user.

In some examples, the first R2X and/or I2R direct communication signal, the second R2X direct communication signal, and/or the third R2X direct communication signal may be based on connectionless communication. Uploads from the second road user to the backend server and downloads by the third road user from the backend server (or any communication between the electronic devices and the backend server) may be based on connection-oriented communication. Advantageously, information associated with the detected event may be exchanged using or combining different communication techniques, including connectionless communication, connection-oriented communication, direct communication, and cloud communication.

In some examples, the second electronic device may be configured to determine a relevance of the detected event for the second road user based on the information associated with the detected event, and to output the determined relevance and/or prepare a countermeasure based on the determined relevance before uploading the information associated with the detected event to the backend server. In other words, the receiving electronic device evaluates the relevance of the received information prior to initiating upload. Advantageously, the second electronic device may prepare and perform countermeasures earlier, thereby mitigating the risk associated with the detected event for the second road user.

In some examples, the electronic device of the first road user and/or the road infrastructure may not be connected to, or may not support communication with, the backend server. In other words, the first electronic device and/or the road infrastructure may be unable to upload the detected event to the backend server directly. In such cases, the first electronic device and/or the road infrastructure is configured to broadcast an R2X and/or I2R direct communication signal that includes information associated with the detected event together with cloud-upload information indicating that the event has not been uploaded to the backend server. Advantageously, the second electronic device may upload the detected event, ensuring that the information is not lost and may still be used to warn other road users.

In some examples, the electronic device of the second road user may be configured to automatically upload the information associated with the detected event to the backend server based on the cloud-upload information. In other words, the second electronic device may upload the received information without requiring any user interaction. Compared to manual cloud submissions that may include inaccurate or delayed position information, automatic uploading yields higher-confidence data. Such high-quality information may not require additional confirmation by the backend server, which significantly reduces computational load.

In some examples, a step of operating the ITS includes detecting an event concerning a threat to road safety by a road infrastructure and/or a first road user in its environment, for example by the first electronic device.

In another step of the method, at least a portion of the information associated with the detected event is uploaded from the road infrastructure and/or the first road user to the backend server based on whether a connection to the backend server is available.

In another step of the method, an R2X and/or I2R direct communication signal including information associated with the detected event is broadcast by the road infrastructure and/or the first road user. The direct communication signal includes cloud-upload information indicating whether the event has been uploaded to the backend server.

In another step of the method, the R2X and/or I2R direct communication signal is received by a second road user.

In another step of the method, at least a portion of the information associated with the detected event is uploaded from the second road user to the backend server based on the cloud-upload information.

In another step of the method, at least a portion of the information associated with the detected event is downloaded from the backend server by a third road user.

In another step of the method, a relevance of the detected event for the third road user is determined based on the downloaded information.

In another step of the method, the determined relevance is output and/or a countermeasure based on the determined relevance is prepared by the third road user.

In some examples, a method for a road infrastructure and/or a first road user is provided. The features and advantages of the method for improving road safety described above may be applied analogously to the method for the road infrastructure and/or the first road user.

In one step of the method for the road infrastructure and/or the first road user, an event concerning a threat to road safety is detected by the road infrastructure and/or the first road user in its environment.

In another step of the method for the road infrastructure and/or the first road user, at least a portion of the information associated with the detected event is uploaded to the backend server based on whether a connection is available.

In another step of the method for the road infrastructure and/or the first road user, an R2X and/or I2R direct communication signal including information associated with the detected event is broadcast. The direct communication signal includes cloud-upload information indicating whether the event has been uploaded to the backend server.

In some examples, a method for the second road user includes receiving an R2X and/or I2R direct communication signal that includes information associated with an event detected by another road user and/or a road infrastructure and that includes cloud-upload information indicating whether the event has been uploaded to the backend server.

In another step of the method for the second road user, at least a portion of the information associated with the detected event is uploaded from the second road user to the backend server based on the cloud-upload information.

In some examples, an electronic device configured to perform the method for a road infrastructure and/or a first road user and/or a second road user is provided. The electronic device may be implemented as part of a control unit of a vehicle. The control unit may be configured to perform the method for a road infrastructure and/or a first road user and/or a second road user. The features and advantages of the methods described herein may be applied analogously to the electronic device and the control unit. For example, a road user may include the electronic device configured to perform any of the described methods. The road user may be a vehicle including a V2X communication module and the control unit. The features and advantages of the electronic device may be applied analogously to the road user.

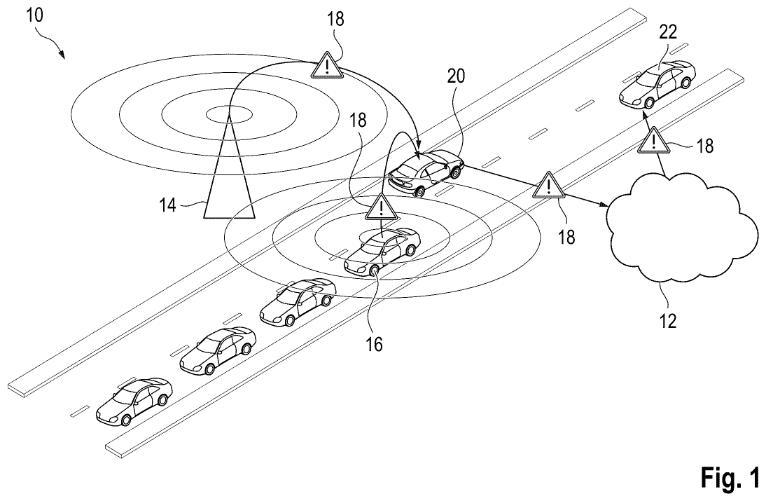

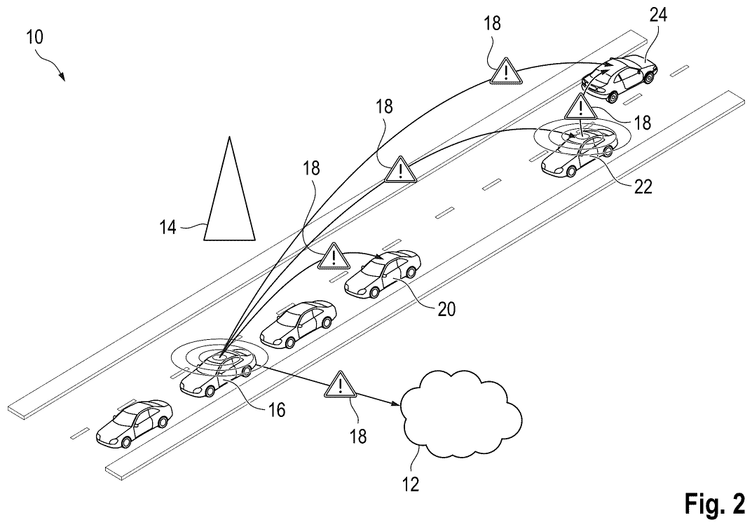

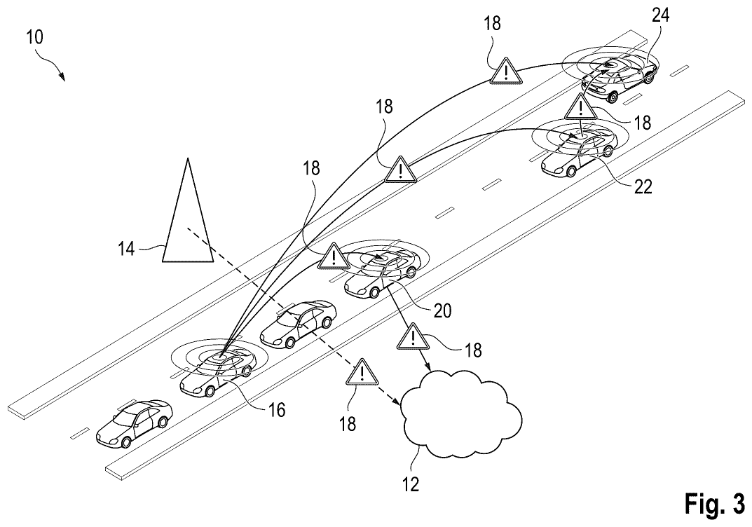

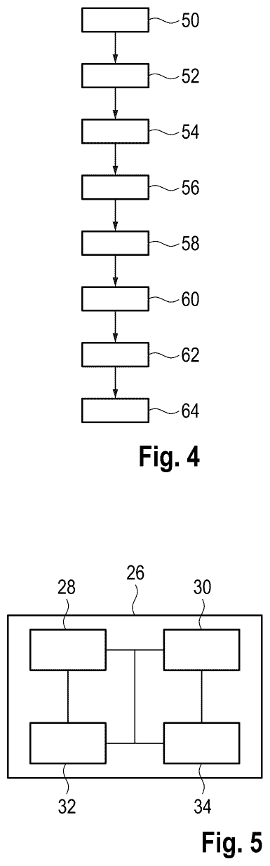

FIG. 1 schematically illustrates an intelligent transport system (ITS) 10 for improving road safety in an exemplary traffic situation according to some aspects of the present disclosure. FIGS. 2 and 3 schematically illustrate the ITS 10 in another exemplary traffic situation according to two further examples. A method for improving road safety, a method for a first road user 16, and a method for a second road user 20 are explained with reference to FIG. 4. The traffic situations shown in FIGS. 1 to 3 are merely representative examples of a wide variety of possible situations, and the present disclosure is not limited to the illustrated scenarios.

The ITS 10 includes a backend server 12, a road infrastructure 14, a first road user 16, a second road user 20, and a third road user 22. Each of the road users 16, 20, 22 includes an electronic device 26, which is described in greater detail with reference to FIG. 5. In one example shown in FIG. 1, the road users 16, 20, 22 are implemented as vehicles. However, at least one or more of the road users 16, 20, 22 may also be a pedestrian, a cyclist, or any other road user carrying the electronic device 26.

The backend server 12 is illustrated in FIGS. 1 to 3 as a cloud symbol to indicate that the backend server 12 provides cloud-based functionality. For example, the backend server 12 may include multiple remotely located servers accessible from any location at any time through a secure and protected Internet connection. Thus, the backend server 12 represents a cloud storage location external to the road users 16, 20, 22, 24, to which data, applications, and computing tasks may be transferred and processed.

The road infrastructure 14 is implemented as a roadside unit (RSU). The road infrastructure 14 may be disposed alongside a road or highway, as shown in FIGS. 1 to 3, to facilitate communication between road users 16, 20, 22, 24 and transportation infrastructure, for example to enable Vehicle-to-Infrastructure (V2I) and Vehicle-to-Everything (V2X) communication. The transportation infrastructure may include sensors configured to detect traffic conditions and/or traffic light status, for example. The road infrastructure 14 includes a communication module configured to exchange information with road users 16, 20, 22, 24 in its vicinity via direct communication. In some examples, the communication module may also communicate with the backend server 12, for example to upload or download data.

In FIG. 1, the first road user 16 represents a vehicle approaching the end of a traffic jam, indicated by a queue of vehicles stationary in front of it. This situation requires the first road user 16 to slow down to avoid a collision. However, another road user such as the third road user 22, driving on the same lane but farther away, may not be aware of the traffic jam and may be inattentive. In such a case, the third road user 22 may need to perform emergency braking, which may catch following road users off guard and significantly increase the risk of an accident.

In the example shown in FIG. 1, the road infrastructure 14 and the first road user 16 are not connected to the backend server 12, whereas the second road user 20 and the third road user 22 are connected to the backend server 12. As a result, events 18 detected by the road infrastructure 14 and/or the first road user 16 cannot be uploaded directly to the backend server 12, and therefore the third road user 22 would otherwise be unable to download and become aware of the detected event 18.

The road infrastructure 14 is configured to detect an event 18 in its environment associated with a threat to road safety—such as the traffic jam shown in FIG. 1—and to broadcast an Infrastructure-to-Road-User (I2R) direct communication signal including information associated with the detected event 18. Additionally, the electronic device of the first road user 16 is also configured to detect the event 18 and to broadcast a Road-User-to-Everything (R2X) direct communication signal including information associated with the detected event 18. These direct communication signals have a limited range, and only road users within the immediate vicinity—e.g., up to approximately 1 km—can receive them.

As shown in FIG. 1, the second road user 20, traveling on the opposite lane, is within the transmission range of the direct communication signals, while the third road user 22 is too far away to receive them. The electronic device of the second road user 20 is configured to receive the R2X and I2R direct communication signals from the road infrastructure 14 and the first road user 16. Rather than discarding the received information about the detected event 18 due to lack of direct relevance to the second road user 20, the electronic device of the second road user 20 uploads the information associated with the detected event 18 to the backend server 12, thereby enriching its database.

As illustrated in FIG. 1, the uploaded data regarding the detected event 18 may be relevant to other road users, such as the third road user 22. By uploading data received through direct communication signals, road safety may be improved because the backend server 12 maintains a more complete and accurate representation of the environment of road users 16 and infrastructures 14. Advantageously, the number of road-user crashes may be significantly reduced, as well as associated fatalities.

The electronic device of the third road user 22 is configured to download the information associated with the detected event 18 from the backend server 12 and to determine a relevance of the detected event 18 based on the downloaded information. The electronic device may output the determined relevance to the driver and/or prepare a countermeasure based on the determined relevance. For example, the electronic device of the third road user 22 may determine that a smooth deceleration is appropriate to reduce the risk of a rear-end collision with the first road user 16, and may present an alert to the driver. Accordingly, the risk of a crash involving the third road user 22 can be reduced, and road safety for the third road user 22 and following road users can be improved.

In contrast with the traffic situation of FIG. 1, FIGS. 2 and 3 illustrate traffic situations in which multiple road users 20, 22, 24 may receive the R2X and/or I2R direct communication signal and may each upload the event information to the backend server 12. In such cases, the communication network may become congested, and the backend server 12 may store a large number of redundant entries, resulting in slower response times and database inefficiencies.

To prevent redundant uploads of the same event information to the backend server 12, the road infrastructure 14 and the electronic device of the first road user 16 are configured to broadcast the R2X and/or I2R direct communication signal including cloud-upload information indicating whether the event 18 has already been uploaded to the backend server 12.

A receiving road user, such as the second road user 20, uploads the information associated with the detected event 18 to the backend server 12 based on the cloud-upload information. For example, if the cloud-upload information indicates that the event 18 has already been uploaded—e.g., by the road infrastructure 14 or by the electronic device of the first road user 16—the second road user 20 does not upload the information again. Advantageously, the resulting database of the backend server 12 remains relatively lean and contains high-quality information.

The traffic situations illustrated in FIGS. 2 and 3 differ at least in that the electronic device of the first road user 16 in FIG. 2 is connected to the backend server 12, whereas the electronic device of the first road user 16 in FIG. 3 is not connected or is not connectable to the backend server 12. The connectivity of the first road user 16 to the backend server 12 may vary depending on the traffic scenario and is not fixed across all examples.

As shown in FIG. 2, the electronic device of the first road user 16 detects an event 18, such as a traffic jam, which is not present in its memory, and uploads the information associated with the detected event 18 to the backend server 12. The electronic device of the first road user 16 also broadcasts an R2X direct communication signal including cloud-upload information indicating that the event 18 has been uploaded to the backend server 12 (“Yes”).

The electronic devices of the second road user 20, the third road user 22, and a fourth road user 24 are likewise connected to the backend server 12 and receive the R2X direct communication signal including the information associated with the detected event 18 and the cloud-upload information. Because the cloud-upload information indicates “Yes,” the information associated with the detected event 18 is stored in the respective memories of these electronic devices but is not uploaded to the backend server 12.

For example, the third road user 22 may also detect the event 18, i.e., the same traffic jam previously reported by the first road user 16. However, because the event 18 is already present in the memory of the electronic device of the third road user 22, the third road user 22 does not upload the information associated with the event 18 to the backend server 12. Instead, the electronic device of the third road user 22 broadcasts an R2X direct communication signal including cloud-upload information indicating that the event 18 has already been uploaded by another road user (“Not needed”). In this way, road users outside the broadcast range of the first road user 16 and not connected to the backend server 12 may nonetheless receive the information associated with the detected event 18 from the third road user 22 and may refrain from redundantly uploading the same event.

In a situation where the third road user 22 in FIG. 2 is neither connected to the backend server 12 nor receives the R2X direct communication signal including the cloud-upload information “Yes” from the first road user 16, the third road user 22 may broadcast an R2X direct communication signal upon detecting the event 18 with cloud-upload information indicating that the event has not yet been uploaded (“No”). If the fourth road user 24 receives both the R2X direct communication signal from the first road user 16 including cloud-upload information “Yes” and the R2X direct communication signal from the third road user 22 including cloud-upload information “No,” the electronic device of the fourth road user 24 matches the events 18 and broadcasts a forwarding R2X direct communication signal including cloud-upload information “Yes.” When the third road user 22 receives this forwarding R2X direct communication signal, it updates its cloud-upload information from “No” to “Not needed” in subsequent broadcasts to prevent redundant uploads of the event 18 by other road users.

When the first road user 16 later detects a termination of the event 18, the electronic device of the first road user 16 may upload the termination information to the backend server 12 and broadcast a termination R2X direct communication signal including the termination information and cloud-upload information “Yes.” The electronic devices of the second to fourth road users 20, 22, 24 may receive the termination R2X direct communication signal and store the termination information in their respective memories without uploading it to the backend server 12, again based on the cloud-upload information “Yes.”

In contrast with the embodiment shown in FIG. 2, the electronic device of the first road user 16 in FIG. 3 is not able to connect to the backend server 12. Thus, the electronic device of the first road user 16 detects an event 18, such as a traffic jam, not stored in its memory and broadcasts an R2X direct communication signal including cloud-upload information indicating that the event 18 has not been uploaded (“No”). The electronic devices of the second to fourth road users 20, 22, 24 receive this R2X direct communication signal including cloud-upload information “No.”

In the example shown in FIG. 3, the road infrastructure 14 has detected the event 18 and uploaded corresponding information to the backend server 12 (as symbolized by the dotted arrow). The electronic devices of the second to fourth road users 20, 22, 24 may have downloaded the event 18 from the backend server 12 and determined that uploading is unnecessary due to a match of the event information, despite receiving an R2X direct communication signal including cloud-upload information “No.” These electronic devices may broadcast forward R2X direct communication signals including cloud-upload information “Yes” or “Not needed” to prevent redundant uploads. When the first road user 16 receives one of these forward R2X direct communication signals including cloud-upload information “Not needed,” the first road user 16 may update its cloud-upload information from “No” to “Not needed” in subsequent R2X direct communication signals to prevent redundant uploads.

In another case, where the road infrastructure 14 has not detected the event 18 or uploaded it to the backend server 12, the event 18 is not stored in the backend server 12 and none of the electronic devices of the second to fourth road users 20, 22, 24 has corresponding event information stored. Thus, any of these road users could upload the event information. To avoid redundant uploads, the electronic devices of the second to fourth road users 20, 22, 24 may be configured to broadcast a third R2X direct communication signal including a Cooperative Awareness Message (CAM) indicating their presence to surrounding road users 16, 20, 22, 24 and, for example, to the road infrastructure 14. The CAM may be extended to include cloud-connected information indicating whether the respective electronic device is connected to the backend server 12.

Based on the cloud-connected information, surrounding road users 16, 20, 22, 24 may determine which road users are connected to the backend server 12. The CAM may be configured to be forwardable once (i.e., with a hop limit of 1) to permit indirect communication with road users 20, 22, 24 located farther from the first road user 16. For example, the first road user 16 may aggregate the CAM information received from the second to fourth road users 20, 22, 24 into a list and broadcast a CAM including the aggregated list. The second to fourth road users 20, 22, 24 may receive this aggregated CAM to become aware of the presence of other road users. Thus, each electronic device of the second to fourth road users 20, 22, 24 may determine whether multiple road users connected to the backend server 12 are present in the environment of the first road user 16 and/or the road infrastructure 14.

When multiple road users 20, 22, 24 are present and connected to the backend server 12, the information associated with the detected event 18 is uploaded from the second electronic device of the second road user 20 to the backend server 12 based on a predetermined condition. The predetermined condition prioritizes which road user is eligible to upload the event information. In the example of FIG. 3, the predetermined condition is shortest distance, and because the second road user 20 is closest to the first road user 16, the second road user 20 is selected to upload the information associated with the detected event 18 to the backend server 12. After uploading, the second road user 20 broadcasts a forward R2X direct communication signal including information associated with the detected event 18 and cloud-upload information “Yes.” The third and fourth road users 22, 24, as well as following road users entering the direct communication range, are thereby prevented from uploading the event information. For example, when the first road user 16 receives this forward R2X direct communication signal, it may update the cloud-upload information in its subsequent broadcasts from “No” to “Yes” to prevent redundant uploads by other road users.

Any of the R2X direct communication signals described herein may further include one or more items of information relating to an event type, an event quality, a time stamp, an action ID, a station ID, a position, a heading, and/or a hop limit.

FIG. 4 schematically shows a flow chart of a method for improving road safety according to an example, which may be used with any of the ITS 10 configurations illustrated in FIGS. 1 to 3.

According to a first step 50, an event 18 concerning a threat to road safety is detected by a road infrastructure 14 and/or a first road user 16 in its environment, for example by the electronic device of the first road user 16 and/or the road infrastructure 14 of the ITS 10.

According to a second step 52, at least a portion of the information associated with the detected event 18 is uploaded from the road infrastructure 14 and/or the first road user 16 to a backend server 12, based on whether a connection to the backend server 12 is available.

According to a third step 54, an R2X and/or an I2R direct communication signal including information associated with the detected event 18 is broadcast by the road infrastructure 14 and/or the first road user 16. The R2X and/or I2R direct communication signal includes cloud-upload information indicating whether the event 18 has been uploaded to the backend server 12.

According to a fourth step 56, the R2X and/or I2R direct communication signal is received by a second road user 20.

According to a fifth step 58, at least a portion of the information associated with the detected event 18 is uploaded from the second road user 20 to the backend server 12 based on the cloud-upload information.

According to a sixth step 60, at least a portion of the information associated with the detected event 18 is downloaded from the backend server 12 by a third road user 22.

According to a seventh step 62, a relevance of the detected event 18 for the third road user 22 is determined based on the downloaded information.

According to an eighth step 64, the determined relevance is output and/or a countermeasure based on the determined relevance of the detected event 18 is prepared, for example by the electronic device of the third road user 22.

The method steps relating to the first road user 16 may be considered as a separate method according to aspects of the present disclosure, and the method steps relating to the second road user 20 may be considered as another method according to aspects of the present disclosure. Accordingly, FIG. 4 also schematically illustrates a flow chart of a method for a first road user 16 and a flow chart of a method for a second road user 20. The method for a first road user 16 includes steps 50 through 54, and the method for a second road user 20 includes steps 56 and 58.

FIG. 5 schematically shows an electronic device 26 for a road user according to some aspects of the present disclosure. The electronic device 26 may correspond to the electronic device of the first road user 16 and/or the second road user 20. However, the present disclosure is not limited thereto, and any of the road users 16, 20, 22, 24 illustrated in FIGS. 1 to 3 may include an electronic device 26 as shown in FIG. 5.

The electronic device 26 includes an R2X communication module 28, a sensor unit 30 configured to at least partially scan the environment of the electronic device 26 for events 18 concerning a threat to road safety, a processor 32, and a memory 34. The sensor unit 30 may include at least one camera or a camera system including a plurality of cameras, such as a surround-view camera system. The processor 32 is configured to detect an event 18 based on sensor data from the sensor unit 30 and to broadcast and/or receive an R2X direct communication signal including information associated with the detected event 18, including cloud-upload information indicating whether the event 18 has been uploaded to the backend server 12, using the R2X communication module 28. The R2X direct communication signal may include an event type, an event position, an event time at which the event 18 was detected, and/or a type of detection means.

The direct communication and/or communication with the backend server 12 and between the road users 16, 20, 22, 24 and/or the road infrastructure 14 may be based on exchanged radio-frequency signals, such as Bluetooth, Ultra-Wideband, Wireless LAN, 4G and/or 5G mobile telecommunications technologies, among others. However, the present disclosure is not limited to these technologies.

### LIST OF REFERENCE SIGNS

10 intelligent transport system
12 backend server
14 road infrastructure
16 first road user
18 event concerning a threat to road safety
20 second road user
22 third road user
24 fourth road user
26 electronic device
28 communication module
30 sensor unit
32 processor
34 memory
50 first method step-detecting an event
52 second method step-uploading event
54 third method step-broadcasting direct communication signal
56 fourth method step-receiving direct communication signal
58 fifth method step-uploading the detected event
60 sixth method step-downloading the detected event
62 seventh method step - determining relevance of the event
64 eighth method step-outputting the determined relevance

1. An intelligent transport system for improving road safety, comprising:
a backend server;
a road infrastructure and a first road user, each comprising an electronic device configured to
detect an event in an environment of the road infrastructure or the first road user, the event concerning a threat to road safety,
determine whether a connection to the backend server is available,
upload at least a portion of information associated with the detected event to the backend server based on whether the connection is available, and
broadcast a road-user-to-everything (R2X) direct communication signal and/or an infrastructure-to-road-user (I2R) direct communication signal comprising information associated with the detected event, the R2X and/or I2R direct communication signal further comprising cloud-upload information indicating whether the event has been uploaded to the backend server;
a second road user comprising a second electronic device configured to receive the R2X and/or I2R direct communication signal and upload at least a portion of the information associated with the detected event to the backend server based on the cloud-upload information; and
a third road user comprising a third electronic device configured to
download at least a portion of the information associated with the detected event from the backend server,
determine a relevance of the detected event for the third road user based on the downloaded information, and
output the determined relevance and/or prepare a countermeasure based on the determined relevance.

2. The intelligent transport system of claim 1, wherein the threat to road safety relates to a road hazard, a driving-environment condition, and/or a traffic condition.

3. The intelligent transport system of claim 1, wherein the second electronic device is further configured to upload at least a portion of the information associated with the detected event if the cloud-upload information indicates that the event has not been uploaded to the backend server and broadcast a second R2X direct communication signal comprising the information associated with the detected event and cloud-upload information indicating that the event has been uploaded to the backend server.

4. The intelligent transport system of claim 1, wherein the first electronic device is further configured to identify that information associated with the detected event was stored in a memory of the first electronic device prior to detection of the event and set the cloud-upload information included in the R2X and/or I2R direct communication signal to indicate that uploading the event to the backend server is not needed.

5. The intelligent transport system of claim 1, wherein the second electronic device is further configured to identify that information associated with the detected event was stored in a memory of the second electronic device prior to receiving the R2X and/or I2R direct communication signal and broadcast a second R2X direct communication signal comprising the information associated with the detected event and cloud-upload information indicating that uploading the event to the backend server is not needed.

6. The intelligent transport system of claim 1, wherein the R2X and/or I2R direct communication signal further comprises cloud-reference-time information indicating a time at which the event was uploaded to the backend server.

7. The intelligent transport system of claim 1, wherein the second electronic device is further configured to
broadcast a third R2X direct communication signal comprising a Cooperative Awareness Message (CAM) indicating a presence of the second road user, the CAM further comprising cloud-connected information indicating whether the second electronic device is connected to the backend server and being configured for forwarding once by a receiver,
wherein the road infrastructure and/or the first electronic device is further configured to receive and forward the third R2X direct communication signal via broadcast and receive and forward one or more R2X direct communication response signals via broadcast,
and wherein the second electronic device is further configured to receive the one or more R2X direct communication response signals and determine whether a plurality of road users connected to the backend server is present in an environment of the first road user and/or the road infrastructure,
and wherein uploading the information associated with the detected event from the second road user to the backend server is further based on a predetermined condition when the plurality of connected road users is present.

8. The intelligent transport system of claim 7, wherein the predetermined condition corresponds to a distance to the first road user and/or the road infrastructure and/or a connectivity parameter with respect to the backend server.

9. The intelligent transport system of claim 8, wherein the distance is determined based on location information included in exchanged CAMs and/or by time-of-flight measurements of direct communication signals exchanged between road users.

10. The intelligent transport system of claim 1, wherein the R2X and/or I2R direct communication signal includes or consists of a Decentralized Environmental Notification Message, DENM, associated with the detected event and extended with the cloud-upload information.

11. The intelligent transport system of claim 1, wherein the first R2X and/or I2R direct communication signal, the second R2X direct communication signal, and/or the third R2X direct communication signal is based on connectionless communication, and wherein uploading from the second road user to the backend server and/or downloading by the third road user from the backend server is based on connection-oriented communication.

12. An electronic device for a road user, comprising:
a processor operatively coupled to a memory;
a road-user-to-Everything (R2X) communication module operably coupled to the processor; and
a sensor unit operably coupled to the processor;
wherein the processor is configured to:
detect an event in an environment of the electronic device based on sensor data from the sensor unit;
determine whether a connection to a backend server is available;
upload at least a part of information associated with the detected event to the backend server based on whether the connection is available; and
broadcast an R2X direct communication signal comprising the information associated with the detected event and comprising cloud-upload information indicating whether the information associated with the detected event has been uploaded to the backend server.

13. The electronic device of claim 12, wherein the processor is further configured to receive an R2X direct communication signal comprising information associated with an event detected by another road user or a road infrastructure, and to upload at least a part of the information associated with the event to the backend server based on cloud-upload information included in the received R2X direct communication signal.

14. The electronic device of claim 12, wherein the sensor unit comprises at least one camera or a camera system comprising a plurality of cameras configured to scan at least a part of an environment of the electronic device for the event.

15. The electronic device of claim 12, wherein the processor is further configured to identify that information associated with the detected event was stored in the memory prior to detection of the event, and to set the cloud-upload information included in the broadcast R2X direct communication signal to indicate that uploading of the event to the backend server is not needed.

16. The electronic device of claim 12, wherein the processor is further configured to broadcast a second R2X direct communication signal comprising a Cooperative Awareness Message (CAM) for indicating a presence of the electronic device to surrounding road users or a road infrastructure, the CAM comprising cloud-connected information indicating whether the electronic device is connected to the backend server.

17. The electronic device of claim 16, wherein the processor is further configured to receive one or more R2X direct communication response signals corresponding to the CAM, determine whether a plurality of road users connected to the backend server are present in an environment of the electronic device, and upload the information associated with the detected event to the backend server based on a predetermined condition when the plurality of road users connected to the backend server is present.

18. The electronic device of claim 17, wherein the predetermined condition corresponds to a distance between the electronic device and another road user or the road infrastructure, or to a connectivity of the electronic device to the backend server.

19. The electronic device of claim 18, wherein the distance is determined based on location information included in exchanged Cooperative Awareness Messages (CAMs) or based on time-of-flight measurements of direct communication signals exchanged between road users.

20. A non-transitory computer-readable storage medium comprising instructions that, when executed by at least one processor of an electronic device for a road user, cause the processor to:
detect an event in an environment of the electronic device based on sensor data;
determine whether a connection to a backend server is available;
upload at least a part of information associated with the detected event to the backend server based on whether the connection is available;
broadcast a road-user-to-Everything (R2X) direct communication signal comprising the information associated with the detected event and comprising cloud-upload information indicating whether the information associated with the detected event has been uploaded to the backend server;
receive an R2X direct communication signal comprising information associated with an event detected by another road user or a road infrastructure;
upload at least a part of the information associated with the event to the backend server based on cloud-upload information included in the received R2X direct communication signal;
determine whether a plurality of road users connected to the backend server are present in an environment of a first road user or a road infrastructure based on Cooperative Awareness Message (CAM) information; and
output a relevance indication of the detected event and/or initiate a countermeasure based on the relevance indication.
